(19) United States
(12) Patent Application Publication
(10) Pub. No.: US 2021/0080411 A1
(43) Pub. Date: Mar. 18, 2021

(54) METHOD OF GENERATING LOCAL ELECTRIC FIELDS

(71) Applicant: Okinawa Institute of Science and Technology School Corporation, Okinawa (JP)

(72) Inventors: Keshav Moreshwar Dani, Okinawa (JP); Michael Ka Lun Man, Okinawa (JP); E Laine Wong, Okinawa (JP)

(21) Appl. No.: 16/982,428

(22) PCT Filed: Apr. 17, 2019
(86) PCT No.: PCT/JP2019/016464

§ 371 Date: Sep. 18, 2020

Related U.S. Application Data
(60) Provisional application No. 62/660,818, filed on Apr. 20, 2018.

(51) Int. Cl. G01N 23/227

(52) U.S. Cl. CPC G01N 23/227; G01N 2223/6113

(57) ABSTRACT

A system and method for redistributing photoexcited electrons and generate local currents within an optical spot on ultrafast timescales achieving in high-speed, high-resolution control of opto-electronic phenomena is disclosed. Selectively addressing sub-populations of photoexcited electrons within the distribution is necessary. By exploiting the spatial intensity variations in an ultrafast light pulse, local surface fields are generated within the photoexcitation spot of a doped semiconductor, which pull apart the photoexcited electrons into two separate distributions. This redistribution process can be controlled via the spatial profile and intensity of the photoexciting pulse.

### RELATED APPLICATION DATA AND CLAIM OF PRIORITY

This application is a U.S. National Stage Application filed under 35 U.S.C. § 371 of International Patent Application No. PCT/JP2019/016464 entitled “METHOD OF GENERATING LOCAL ELECTRIC FIELDS”, filed Apr. 17, 2019, which claims priority to U.S. Application No. 62/660,818, filed Apr. 20, 2018, the contents of which are incorporated by reference for all purposes as if fully set forth herein.

### TECHNICAL FIELD

This invention is concerning a method of generating local electric fields that drive spatially varying currents within an optical spot of a semiconductor.

### BACKGROUND

The spatial and temporal dynamics of charged particles at the interfaces of materials is of vital consequence to several modern technologies, including but not limited to light-harvesting and semiconductor devices. For example, the mobility of carriers and the underlying nature of diffusion raise important questions relevant to semiconductor device technology. In the case of photocatalysis, where light energy is converted to chemical energy at the surface of a semiconductor, spatio-temporal dynamics of the photocarriers can directly impact chemical reactions at that surface. To further these scientific and technological aims, over the past few years, a handful of techniques have begun to study the dynamics of photocarriers simultaneously in space and time with high resolution.

Ultrafast micro pump-probe techniques which interpret the measured, spatially resolved optical response to understand the underlying carrier dynamics, have observed drift and diffusion phenomena in semiconductor nanostructures. One such method of measurement is scanning ultrafast electron microscopy (SUEM), which utilizes ultrafast electronic packets to obtain high spatio-temporal resolution. SUEM can be used to measure secondary electrons emitted by a probe electron packet to access the photoexcited carrier dynamics. As a result, SUEM has recently observed anomalous and anisotropic diffusion phenomena in amorphous silicon and black phosphorous respectively. However, the measurements achieved this way still lack certainty and rigor.

### Technical Problem

Consequently, an improved system and method for study the dynamics of photocarriers simultaneously in space and time with high resolution is desired.

### SUMMARY OF THE INVENTION

A system and method for redistributing photoexcited electrons and generate local currents within an optical spot on ultrafast timescales achieving in high-speed, high-resolution control of opto-electronic phenomena is disclosed. Selectively addressing sub-populations of photoexcited electrons within the distribution is necessary. By exploiting the spatial intensity variations in an ultrafast light pulse, local surface fields are generated within the photoexcitation spot of a doped semiconductor, which pull apart the photoexcited electrons into two separate distributions. Using time-resolved photoemission microscopy, it is then possible to directly record a movie of this redistribution process, which can be controlled via the spatial profile and intensity of the photoexciting pulse. An intuitive and quantitative model explains the underlying charge transport phenomena, thus providing a roadmap to the more generalized ability to manipulate photocarrier distributions with high spatio-temporal resolution.

The embodiments herein demonstrate a novel capability to move and redistribute photoexcited electrons within the optical spot on ultrafast timescales. This is achieved by generating local electric fields with high spatiotemporal resolution using light that drives current within an optical spot, and manipulating the distribution of photoelectrons.

In the past, a conventional example of manipulating the distribution of photocarriers is the separation of unlike charges—e.g. electrons and holes, via an electric field or energy gradient. This has been the cornerstone of various opto-electronic technologies to date solar cells, photodetectors, and others. On the other hand, being able to manipulate distributions of like photocarriers, say electrons, with high spatio-temporal resolution would provide another, perhaps even more powerful, platform for future opto-electronic control. For example, one could generate local currents that rapidly pull apart portions of the photoexcited electron distribution, and use them to power tiny opto-electronic devices, or to drive site-specific, temporally gated photocatalytic reactions, or to study quantum coherent effects that develop between the spatially separated electron sub-populations.

One difficulty with achieving the above is that manipulating distributions of like photocharges is quite challenging—it requires one to selectively address just one part of the distribution, which can then be separately manipulated from the whole. Even in the broader physics literature, techniques to separate electron populations, such as the Stern-Gerlach apparatus or the partial quantum tunneling through a barrier, are scarce. Moreover, they do not operate on ultrafast timescales and are of limited utility in the case of photoelectrons in materials.

The embodiments herein overcome these and other difficulties. Specifically, using intensity variations in the optical pulse, it is possible to generate local electric fields in a doped semiconductor, which selectively address photo-electron sub-populations and thereby pull apart the original Gaussian distribution of the electrons into two separate distributions on ultrafast timescales. Using a theoretical model to explain and quantitatively reproduce the results of the above steps and procedures, a clear roadmap into arbitrary manipulation of the distribution of photoelectrons (as well as other quasiparticles) with high spatio-temporal resolution is provided.

It is also possible to capture movies of the above redistribution process. These movies may have a duration of only several trillionths of a second, but can be controlled by making alterations to the shape and intensity of an optical pulse.

### BRIEF DESCRIPTION OF THE DRAWINGS

FIGS. 1A and 1B are schematic diagrams of a TR-PEEM and the ultrafast separation of the photoexcited electrons within an optical spot;

FIGS. 2A and 2B show pulling apart photoexcited electrons by optically inducing spatially varying electric fields within the photoexcitation spot at both low (FIG. 2A) and high (FIG. 2B) intensities;

FIG. 3A shows controlling a rate of separation of the photoexcited electron clouds;

FIG. 3B shows fitted peak separations as a ratio of the FWHM for three different pump fluences;

FIGS. 4A, 4B, 4C, and 4D show inhomogeneous screening of the intrinsic fields of a doped semiconductor induce lateral potential differences that pull apart the photoexcited electrons into two distinct distributions;

FIGS. 4E and 4F contrast the results of lower-energy and higher-energy photoexcitation;

FIGS. 5A, 5B, and 5C show formation of an in-plane electric field;

FIGS. 6A, 6B, 6C, and 6D show formation of a diode;

FIG. 7 shows an example photodiode; and

FIGS. 8A, 8B, and 8C show potential usages of the embodiments herein.

### DETAILED DESCRIPTION OF THE PREFERRED EMBODIMENTS

As stated, SUEM has recently observed anomalous and anisotropic diffusion phenomena in amorphous silicon and black phosphorous respectively.

In contrast, time-resolved photoemission electron microscopy (TR-PEEM) techniques combines the high temporal resolution provided by ultrafast optical pulses with the high spatial resolution provided by photoemitted electrons to study dynamic in metals and semiconductors. In semiconductors, TR-PEEM can directly image the density of photoexcited electrons as they evolve in space and time, as exemplified through observation of the motion of electrons in a type-II semiconductor heterostructure.

Beyond the observation of drift and diffusion phenomena in semiconductor structures, it is advantageous to directly control the distribution of charge densities and local currents in space and time with high resolution. Arguably, one of the most potent and useful examples of manipulating photocarrier distribution for modern technology is the separation of unlike photocharges—e.g. electrons and holes, using macroscopic electric fields or energy gradients formed in material heterostructures, such as type-II heterostructures. However, manipulating the distribution of photocarriers of the same charge, e.g. just the electrons, can be challenging due to the relatively few ways to separately address sub-populations of the photocarrier. Furthermore, tools to achieve control with both high spatial and temporal resolution remain scarce.

Light would provide a natural tool to achieve high-speed effects, but it would still be necessary to develop ways to selectively manipulate electrons within the optical spot size to achieve spatial resolution beyond the diffraction limit. Ultimately, such an ability to manipulate the distribution of photoexcited electrons and thereby generate local, spatially varying currents with high spatio-temporal resolution could have significant implications for fast, nanoscale opto-electronic devices, or for site-specific, temporally gated photocatalytic reactions, as well as many other opto-electronic technologies.

Utilizing the spatial variations in the intensity of a Gaussian ultrafast optical beam, it is possible to generate local electric fields that drive spatially varying currents within the optical spot of a p-doped GaAs semiconductor. The local electric fields act to pull apart and separate a single Gaussian distribution into two separate Gaussian distributions of photoexcited electrons. Using TR-PEEM, it is possible to directly image the evolving electron density with high spatial and temporal resolution, and thereby make a movie of the process of separation of the photoexcited electron distribution. By varying the spatial profile and intensity of the ultrafast optical beam, one can control the in-plane electric fields and thus the degree and rate of the separation process.

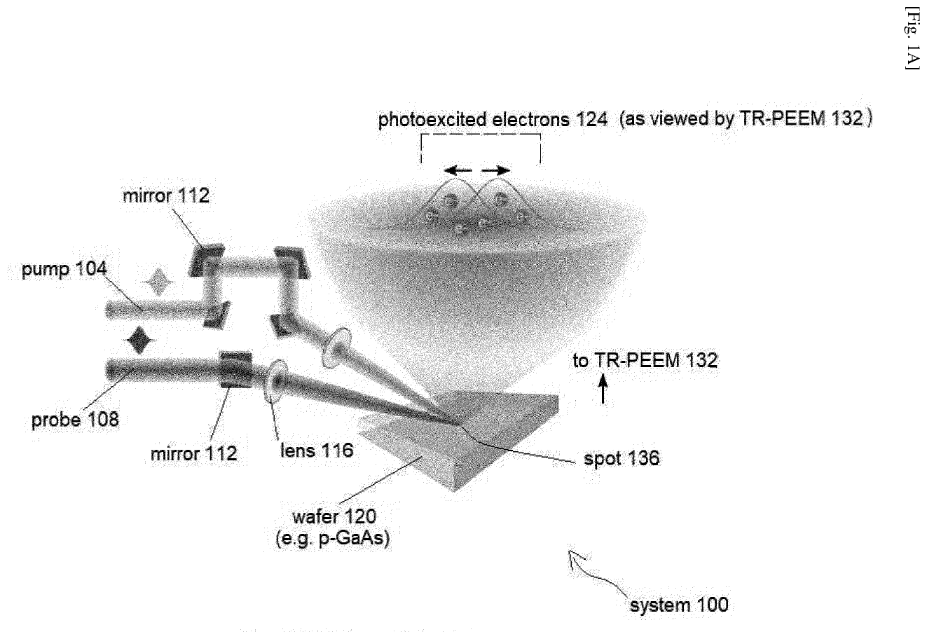

FIGS. 1A and 1B show an example system 100 to understand the process and to reproduce key features of the methods and embodiments herein. Specifically, FIGS. 1A and 1B shows a schematic of a wafer 120 (in an embodiment, a p-doped GaAs wafer) TR-PEEM 132 and the ultrafast separation of the photoexcited electrons 124 within the optical spot 136. As shown in FIGS. 1A and 1B, P-doped GaAs are excited with a pump 104 (operating at e.g. 1.55 eV) and photoemit the photoexcited electrons with a probe 108 (operating at e.g. 4.6 eV) through a series of mirrors 112 and lenses 116.

The photoemitted electrons 124 are imaged in the photoemission electron microscope 132 with high spatial resolution at varying pump-probe delays. Assembling a plurality of these images sequentially can provide a movie demonstrating how to control the redistribution of the photoexcited electrons via optically induced spatially varying in-plane electric fields within the photoexcitation spot 136.

For the embodiments herein, a p-doped GaAs wafer is cleaved in-situ in the ultrahigh vacuum chamber of the photoemission electron microscope (PEEM), thereby exposing a clean surface. The wafer is then photoexcited with a 1.55 eV, 45 fs pump pulse. The photoexcited electrons are then photoemitted with a time-delayed 4.6 eV probe pulse. As shown in FIG. 1, these photoemitted electrons are imaged in the PEEM to form a series of time-delayed images reflecting the evolving spatial distribution of the electrons.

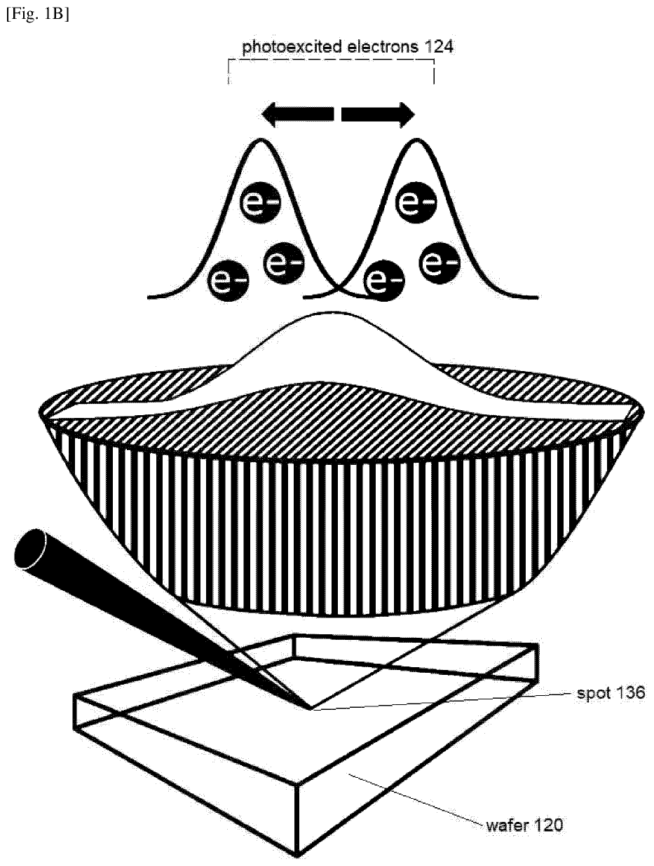

FIGS. 2A and 2B are snapshots showing results of pulling apart photoexcited electrons by optically inducing spatially varying electric fields within the photoexcitation spot 136 at high intensities. Specifically, the various snapshots of FIG. 2 show a normalized spatial distributions of the density of photoexcited electrons at three different time delays after photoexcitation (0 ps, 200 ps and 500 ps) for low (FIG. 2A) and high (FIG. 2B) high photoexcitation fluence. Within FIG. 2A, at 0.075 mJ cm⁻², the photoexcited electrons exhibit well-known diffusion phenomena while retaining a typical Gaussian distribution.

Meanwhile, within FIG. 2B, at 1.12 mJ cm⁻², the initial Gaussian profile of the photoexcited at 0 ps starts to separate at +200 ps and eventually splits into two distinct distributions 204 and 206. In contrast, for higher photoexcitation fluence (FIG. 2B), it becomes possible to induce a non-trivial redistribution of the photoexcited electrons. By +200 ps, the photoexcited electron density deviates significantly from a Gaussian and eventually splits into two distinct Gaussian distributions 204 and 206 at +500 ps with a separation between the two peaks greater than the FWHM of the two fitted Gaussian profiles. The separation between the two fitted Gaussian peaks is greater than the full-width-at-half-maximum (FWHM) of the distributions. Within FIGS. 2A and 2B, the white elliptical lines in the XY plane demarcate the FWHM of the distribution(s).

With the experimental capability shown in FIGS. 2A and 2B, it becomes possible to first image the spatial distribution of the photoexcited electrons at different time delays for low (0.075 mJ cm⁻²) and high (1.12 mJ cm⁻²) pump fluences. The time-delayed images are normalized individually.

A grazing angle of incidence of the pulse from the pump 104 creates an elliptical photoexcitation profile, which provides a strong electric field along the short axis (as explained in more detail below). At the instant of photoexcitation i.e. at 0 ps, the density profile of the photoexcited electrons inherits the Gaussian (bell curve) distribution of the photoexcitation beam.

The intensity profile of the photoexcitation beam provides a strong degree of control over the rate and degree of separation of the photoexcited electrons. This is advantageous and has a wide variety of useful applications.

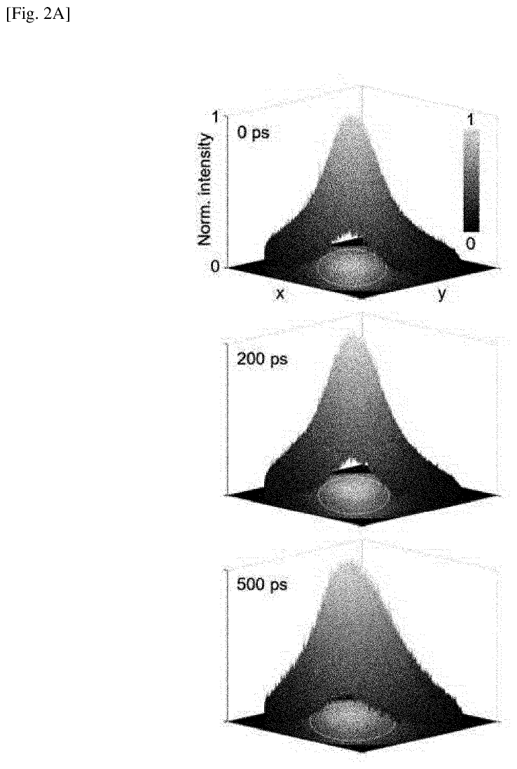

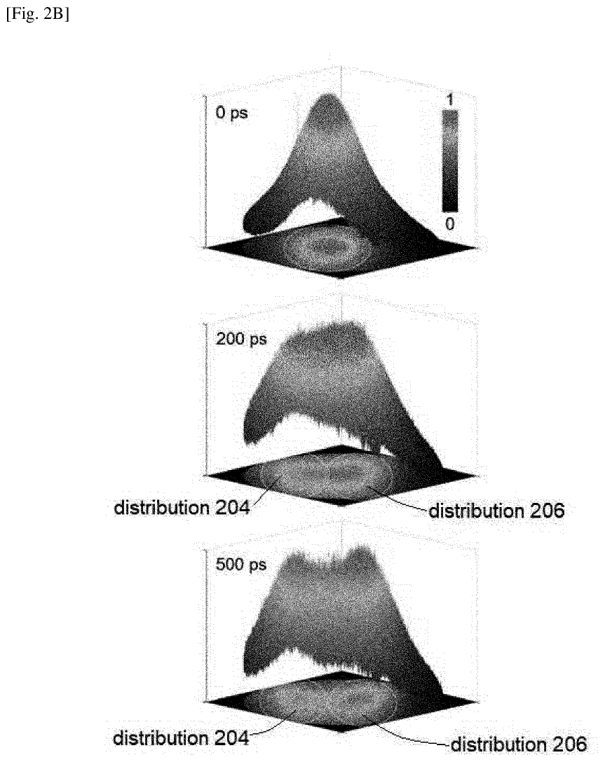

FIGS. 3A and 3B show control of rate of separation of the photoexcited electron clouds. Specifically, FIG. 3A shows the density profile of the photoexcited electrons at +500 ps for three different pump fluences i.e. 0.15 mJ cm⁻², 0.45 mJ cm⁻², and 1.12 mJ cm⁻². The intensity 304 of FIG. 3A refers to photoemission intensity which is proportional to a photoexcited electron density (measured in arbitrary units a.u.). At 0.15 mJ cm⁻², the density profile resembles that of a flat top Gaussian curve, hinting at the splitting of the photoexcited electrons cloud. At 0.45 mJ cm⁻², the density profile now clearly shows two distinct peaks, indicating the presence of two overlapping Gaussian distributions. At 1.12 mJ cm⁻², the two peaks have now moved even further apart, showing a larger separation between the two distributions of photoexcited electrons.

In FIG. 3B, the peak separation is plotted versus time delay for three different fluences as a ratio of the FWHM at +500 ps. The black horizontal line thus marks the point where the separation between the two peaks is equal to the FWHM of the two Gaussian distributions, indicating two resolved Gaussian distributions as per the FWHM criterion. This demonstrates that the rate of separation and the eventual separation of the photoexcited electron cloud can be controlled by the photoexcitation intensity. Such control is valuable for a variety of reasons.

FIG. 3A shows a density profile at +500 ps for three different pump fluences ranging from a flat top Gaussian to two overlapping Gaussian distributions with varying amount of separations. For quantitative analysis, the time-delayed density profiles are fitted with two Gaussian distributions of the same width and amplitude, leaving the peak positions as free parameters for fitting. The solid black lines show the density profiles that arise from the two fitted overlapping Gaussian distributions (solid grey lines). The degree and rate of separation of the can be controlled by tuning the photoexcitation fluence.

Some context may be helpful at this point, starting with an explanation of generating in-plane electric fields arising from intensity variations in the photoexciting Gaussian pulse. Within the embodiments herein, prior to photoexcitation, a layer of positive charge exists at the surface of a p-doped semiconductor, which in turn is balanced by the depletion layer of negatively charged dopants and results in the well-known band bending seen in doped semiconductors. Within this disclosure, the expression surface bands will be understood to mean valence and conduction bands which are found at the surface of a typical semiconductor.

Upon the optical injection of carriers from the pump 104 in FIG. 1, photoexcited electrons and holes screen the pre-existing dipoles causing this intrinsic surface field to diminish and surface bands to unbend, depending on the photoexcitation density. In areas of large photoexcitation density, the intrinsic field is fully screened and the semiconductors bands (e.g. valence band Ev, and conductor band Ec) are fully flattened. In contrast, in regions of low photoexcitation density, the intrinsic field is largely unaffected by the few photoexcited carriers, and the band remains bent as before.

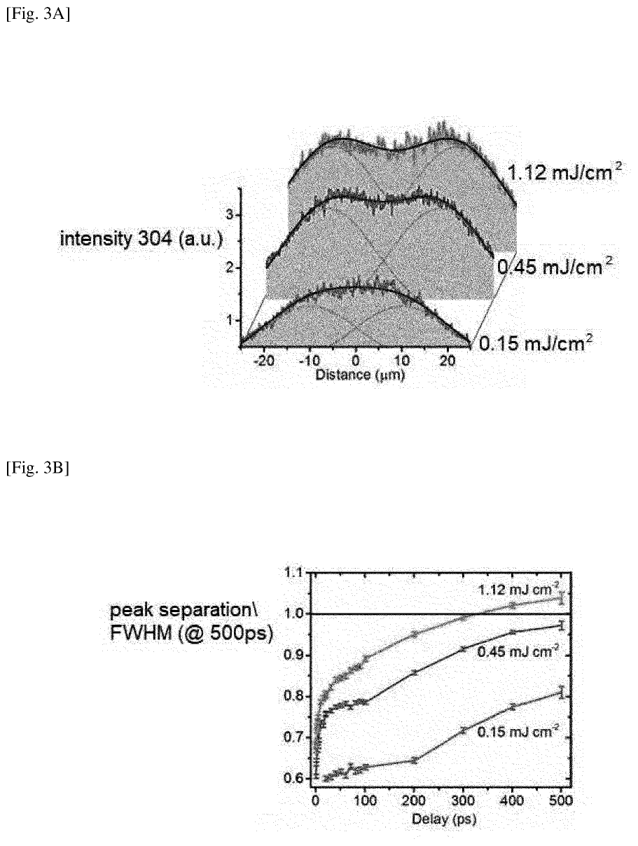

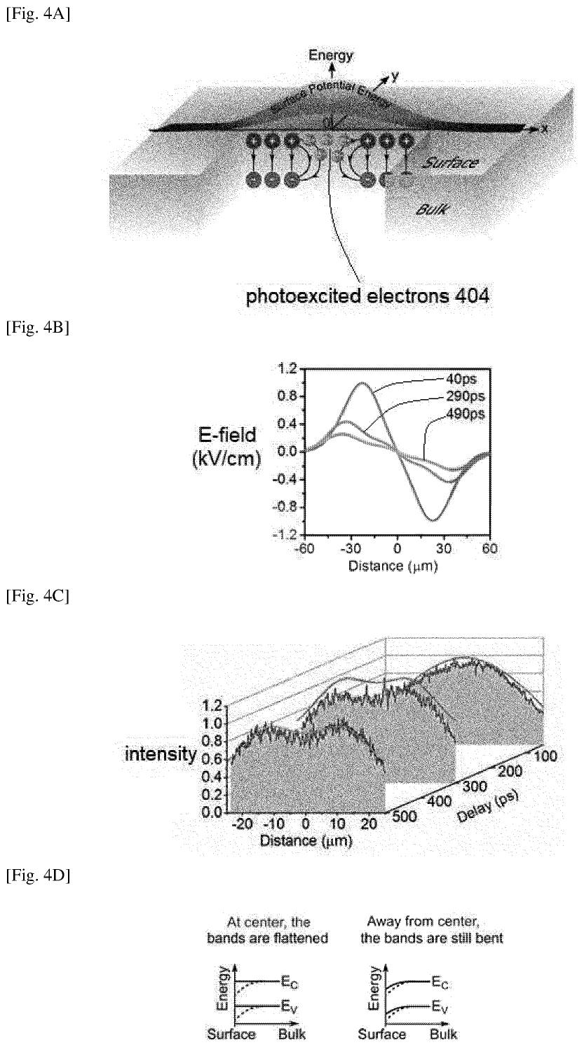

In the embodiments herein, under the right intensity conditions, an almost completely screened region at the center of the Gaussian pulse and regions with a finite intrinsic field away from the center are left behind. Thus, as shown in FIG. 4A, the non-uniformly screened intrinsic surface field leads to lateral variations in the amount of band bending, and accordingly a lateral potential difference on the surface. The lateral potential difference directly corresponds to an in-plane electric field radiating away from the center that starts to pull apart the photoexcited electrons.

By using a grazing angle of incidence corresponding to an elliptical photoexcitation profile, it is possible to weaken the strength of the electric field along the long axis of the ellipse thereby ensuring the electrons are pulled apart only in the direction of the short axis. This is another example of the utility and usefulness of the embodiments herein. The ability to control the pulling of the electrons is advantageous and has many practical and industrial applications.

FIGS. 4A-D shows the inhomogeneous screening of the intrinsic fields of a doped semiconductor induce lateral potential differences that pull apart the photoexcited electrons into two distinct distributions. To quantitatively model the observed phenomena, a first step would be to numerically calculate the local electric field and its effect on the photocarrier distribution, both of which evolve over time. Within FIG. 4A, the plus symbols are a layer of positive charges at the surface. Meanwhile, the minus symbols are the layer of negative charges in the bulk. The x-axis in FIG. 4A symbolizes the distance from the center of the photoexcitation profile. The x-axis labelled ‘Surface→Bulk’ in FIG. 4D symbolizes the distance from the material surface.

The axes labelled ‘Distance’ in FIG. 4B and FIG. 4C both refer to the distance from the center of the photoexcitation profile. FIG. 4A shows the spatially varying intensity of the Gaussian photoexcitation beam inhomogeneously screening the intrinsic surface fields of p-doped GaAs. This screening leads to a flattening of the bands, but does so inhomogeneously, leading to lateral potential differences that drive localized spatially-varying currents.

An important semantic consideration exists with regard to FIG. 4A. Any reasonable person might induce that portions of FIG. 4A are “bended” or “rounded” in the middle and “flattened” at the ends. However, within this disclosure, the terms “flattened” or “flat” and “bent” have kind of a different meaning. Specifically, due to the flattening of the bands at the center of the diagram in FIG. 4A, the energies of the surface bands (Conduction band—Ec and Valence band—Ev, see FIG. 4D) now sit at higher energies than the surface bands further away from the center of the diagram in FIG. 4A. This causes the photoexcited electrons 404 at the center of FIG. 4A to flow away from the center laterally. The electric field is calculated by taking into account the spatial variation in the local densities of dipoles due to the inhomogeneous screening of the dipoles by the photoexcited carriers.

For additional clarification, FIG. 4D shows a graphical representation of the screening occurring in FIG. 4A.

FIG. 4B shows the spatially varying electric field calculated from the evolving distribution of surface dipoles. As the photoexcited electrons redistribute in the lateral field (and recombine), the lateral electric fields evolve and weaken (FIG. 4B), which in turn impacts local currents and the evolving distribution of photocarriers. Eventually, for high initial photoexcitation intensities, the photoexcited electrons separate into two Gaussian distributions.

FIG. 4C shows the calculated (solid lines) evolution of the density of photoexcited carriers closely reproduces the experimental data (blue lines and grey planes) showing the separation of photoexcited electrons into two separate distributions. FIG. 4C shows that the embodiments herein correctly reproduce the degree and rate of separation.

FIG. 4D shows the flattened bands at the center of the laser spot 136 and the bent bands at position away from the center of the laser spot 136.

FIG. 4E shows a build-up of an electric between the surface and bulk of the wafer 120 due to bending of the surface bands. FIG. 4E also shows bending at the surface of the wafer 120, as well as an arrow symbolizing density of photons 470. In contrast, FIG. 4F illustrates a circumstance in which there is zero energy field between the surface and the bulk of the wafer 120 which means the energy bands in the surface are flat or flattened. The dashed lines 476 show the same wafer in its bent state, and are included only for convenient visual comparison of the bent v. flattened states.

In both FIGS. 4E and 4F, Ec is the energy level of the conduction band, Ev is the energy level of the valence band, and Ef is the energy of the Fermi level. The surface states 480 represent various energy states that may be existing at the surface of the wafer 120. The symbol hv is the energy carried by a single photon.

Comparing FIGS. 4E and 4F, it is apparent that the surface bands are flattened at the higher photoexcitation density of FIG. 4F. The thicker arrow of FIG. 4F shows that more photons 470 are rising, due to higher photoexcitation density.

The Point of all this

After having digested the above, it should now be more apparent that the embodiments herein provide a new paradigm in the spatio-temporal control of charge carriers with high resolution. In general, the ability to alter photoexcited electronic distributions within the optical spot 136 opens up the possibility to go beyond the diffraction limit of light to the nanoscale. Further, using spatial light modulators to imprint other non-trivial intensity patterns on the surface, it becomes possible to obtain arbitrary control of charge currents on a nano-scale, or even a femto-scale. These charge currents in turn can be used to drive nanoscale opto-electronic devices, or for localized, temporally-gated photocatalysis with high resolution and unprecedented control.

Another interesting consequence of the ability to spatially separate, and then potentially recombine sub-populations of photoexcited electrons, could be spatial coherences in the photoelectron population. The ability to manipulate spatial quantum coherent effects in photoexcited electron populations would have fundamental as well as technological value. Lastly, the ability to create lateral energy potential differences at the surface via lateral variations in the amount of band bending could allow the flow of other quasi-particle species such as neutral, tightly bound excitons, thus enabling next-generation excitonic technologies.

### Materials and Methods Used Herein

In an embodiment, the composition of the wafer can be Zn-doped GaAs <100> wafer of thickness 350±25 μm. The dopant concentration of the sample was confirmed via Hall Effect measurement to be ˜1.0×10¹⁷ cm⁻³. The sample was heated to 150° C. in an ultrahigh vacuum chamber (˜10⁻¹⁰ Torr) for at least an hour for desorption of gases from the surface. After cooling, the sample was cleaved in-situ and transferred into the main chamber for measurements. The cleaved surface was confirmed with both low energy electron diffraction (LEED) and photoemission imaging (PEEM) to be clean and free of any microscopic ridges.

The TR-PEEM measurements were performed in a LEEM/PEEM system (e.g. SPELEEM, manufactured by Elmitec GmbH) using femtosecond pump-probe technique. The cathode lens design of the microscope allows for non-scanning, high-resolution imaging of the photoemitted electrons with a lateral resolution of ˜40 nm. The femtosecond pulses at a central wavelength of 800 nm and a pulse duration of 45 fs are generated by a high-power (e.g. 2.6 W) high repetition rate (4 MHz) oscillator system. The fundamental pulses were split into two parts: the first part was used as a pump pulse to photoexcite the GaAs sample; the second part was frequency tripled via BBO crystals to 266 nm and used as a time-delayed probe pulse to photoemit electrons from the sample.

Due to the low photon energy of the probe and the electron affinity of the sample, only the photoexcited electrons are photoemitted from the sample. Both the pump and the probe pulses were focused onto the sample at a grazing angle of 18°. The diameter of the short axis of the pump elliptical spot 136 was ˜30 μm FWHM. The probe spot was a few hundred micrometers wide to achieve uniform illumination of the field-of-view of the sample. The temporal resolution of the measurement is obtained from the rise time of the pump-probe signal to be ˜280 fs, due to the stretching of the frequency-tripled probe. The LEED pattern of the sample was taken both before and after the measurements to rule out any significant surface change over the course of the measurements.

### Formation of a Lateral Electric Field

At equilibrium, the surface band bending of a p-type GaAs leaves behind a positively charged surface that is balanced by the negatively charged regions beneath the surface, i.e. the depletion region. Upon photoexcitation, this intrinsic surface space charge field causes the photoexcited electrons to drift towards the surface and the holes to drift towards the bulk. This separation of the photoexcited carriers will in turn lead to the buildup of an opposite electric field that will then “screen” the intrinsic surface space charge field. The inhomogeneous distribution of the photoexcited carriers leads to a spatially nonuniform screening of the intrinsic field. The gradient of unscreened positive surface charges gives rise to an in-plane surface electric field that acts upon the photoexcited electrons, pulling them apart as observed at least within FIG. 2B.

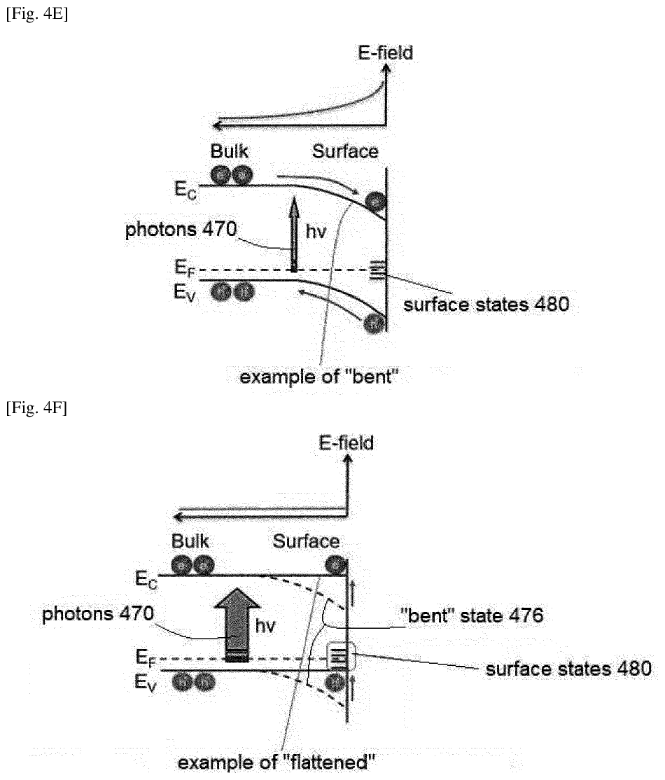

FIGS. 5A-5C show a formation of the in-plane (lateral) electric field. FIG. 5A shows a surface space charge field that is modelled as a layer of dipoles. To verify that the spatially nonuniform screening of the intrinsic field will indeed lead to the buildup of a lateral electric field along the surface, it was found advantageous to qualitatively modelled the surface space charge field as a layer of dipoles separated by a width ‘w’ of the depletion region. This is shown in FIG. 5A.

FIG. 5B shows a layer of positive charges along the surface attracts the surface photoexcited electrons 512 while the layer of negative charges in the depletion region repels the surface photoexcited electrons 512. The scenario shown within FIG. 5B demonstrates that the photoexcited electrons at the center experience a lateral pull outwards towards the unscreened positive surface charges while the negative charges deeper within push the photoelectrons back towards the center. Regarding the symbols within FIG. 5B, the ‘w’ is the width of the depletion region, the arrow 504 symbolizes a “repel” or “push” effect. The arrows symbolize the force exerted onto the photoelectrons by the surrounding charges. +ve charges pull the photoexcited electrons and −ve charges repel (push) the photoexcited electrons.

The layer 508 refers to a layer of negative charges in a depletion region. The X-axis is the surface of the wafer 120, the +++ is the layer of positive charges, and the e− are the photoexcited charges at the surface.

Due to the longer distance, the photoelectrons closer to the positive surface charges in the +x direction will experience a net attractive pull towards the +x direction, and vice versa for the electrons closer to the positive surface charges in the −x direction. Finally, FIG. 5C shows a nontrivial spatially varying in-plane electric field that arises from the unscreened dipoles.

As such, the surface electric field due to these positive surface charges is

$${E}_{+} ( a ) = - \frac{q}{2 {πɛ}_{0}} \int σ [ 1 - {e}^{\frac{- {x}^{2}}{2 {c}^{2}}} ] \frac{dx}{( x - a )}$$

where σ is the surface charge density. Correspondingly, the surface electric field in the x-direction due to the negative charges at z=−w is

$${E}_{-} ( a ) = \frac{q}{2 {πɛ}_{0}} \int σ [ 1 - {e}^{\frac{- {x}^{2}}{2 {c}^{2}}} ] \frac{( x - a ) dx}{{( x - a )}^{2} + {w}^{2}}$$

and the resultant surface electric field due to this layer of dipoles is as shown in FIG. 5C.

Using this surface electric field, it is then possible to model the lateral transport of the photoelectrons at the surface with the following drift-diffusion equation:

$$\frac{\partial N ( x , t )}{\partial t} = D {∇}^{2} N ( x , t ) + μ E ( x ) ∇ N ( x , t ) - \frac{N ( x , t )}{τ}$$

where N is the electron density, D is the diffusion coefficient, μ is the electron mobility, and τ is the recombination rate. Using the three parameters, D, μ, and τ as fitting parameters, it is possible to qualitatively reproduce the photoexcited electrons distribution profile as shown in FIG. 4D. The fitted values of D, μ, and τ are 85 cm² s⁻¹, 3300 cm²V⁻¹ s⁻¹ and 500 ps respectively.

A field programmable gate array (FPGA) is a semiconductor device made up of reconfigurable logic blocks. Unlike integrated circuits that are designed and fabricated specifically for an application. FPGAs can be reprogram by end users to desired new application or functionality after manufacturing. This has greatly reduced the cost and time for application-specific circuit design as incremental changes to the circuit can now be done within hours instead of weeks spent fabricating the new circuit.

One of the principles of the embodiments herein is the ultrafast, sub-diffraction control of the local surface potential. By manipulating the surface potential with an ultrafast light, we can potentially imprint a temporary logic gate on the sample for as long as the photocarrier lifetime, after which the gate will be erased allowing the sample surface to be reprogram with another logic gate.

### Potential Example Embodiments

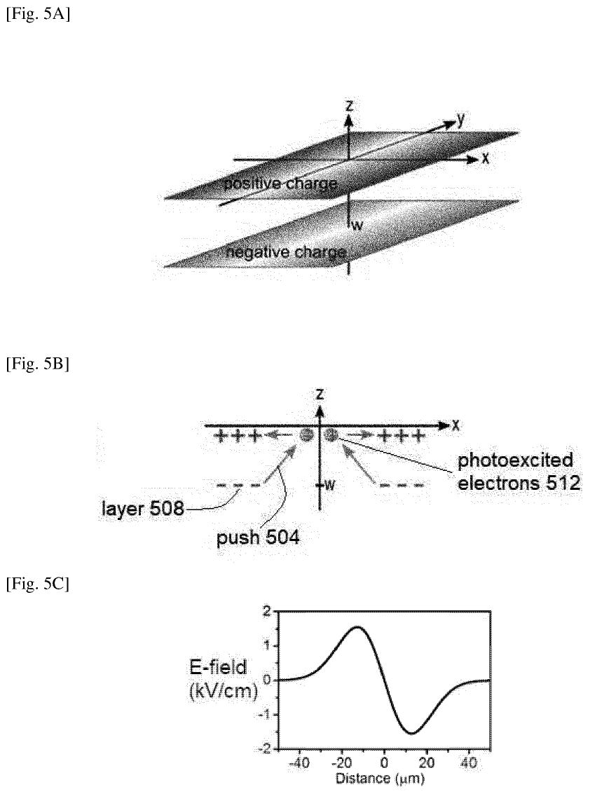

FIGS. 6A-6D show schematics of a reprogrammable diode. A semiconductor diode is a device made up of a p-n junction that will only allow current to flow in one direction. To mimic the operation of a diode, a monolayer graphene is deposited on top of a p-type GaAs. To allow for current flow from left to right, the ultrafast light pulse 624 is shone upon the sample as shown in FIG. 6A. The higher intensity on the left will lift the surface potential higher than that on the right. When the terminals 612 on both sides of the monolayer graphene are connected as shown in FIG. 6A, current will flow from left to right. If the terminals 612 are connected in reverse, both ends of the graphene 620 will be at higher potentials than that at the center and no current will flow, hence mimicking the diode 604 shown in FIG. 6C. And by shining the light in the way as shown in FIG. 6B, the device can now be reprogrammed to mimic the operation of a diode 608 in opposite direction, as shown in FIG. 6D.

By selecting a material with higher bandgap and shorter photocarrier lifetime, nanoscale devices can be reprogrammed with picosecond intervals.

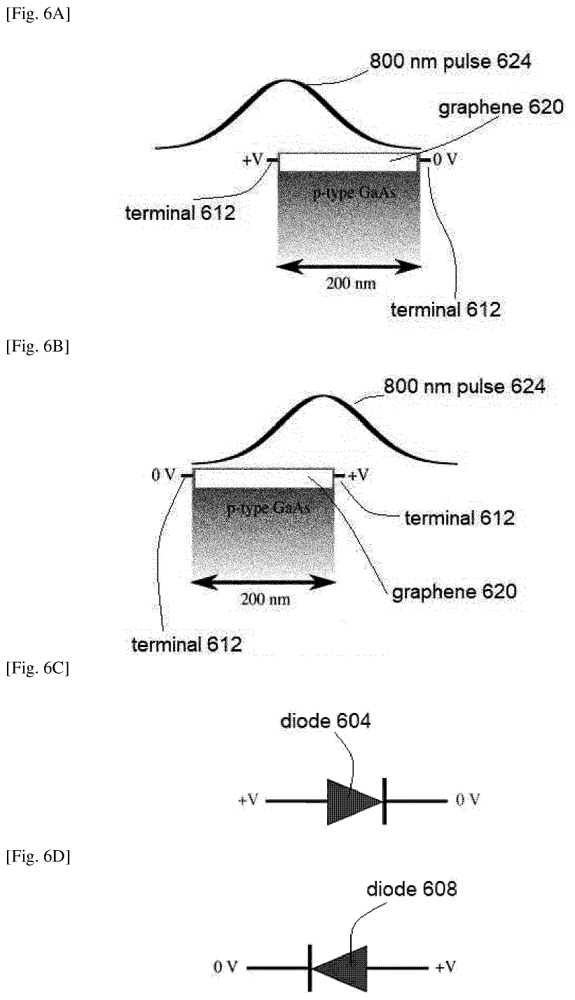

FIG. 7 shows some working principles of a photodiode 700 fabricated using the methods and embodiments described herein. The materials on the opposite sides of the dividing line 704 conventionally have different band alignments, but within the embodiments herein can be a single material with the same doping concentration. The two materials on either side can be different, such as InSe and GaAs, or they can be the same materials with different doping concentrations such as p-GaAs and n-GaAs. The important fact is that both sides cannot be the same materials with the same doping concentrations, as there would not be an offset in the bands alignment. In comparison to the conventional photodiode, the embodiments described herein can achieve similar function with one single material with the same doping concentration. The bands alignment offset is achieved via the photoexcitation profile as described herein.

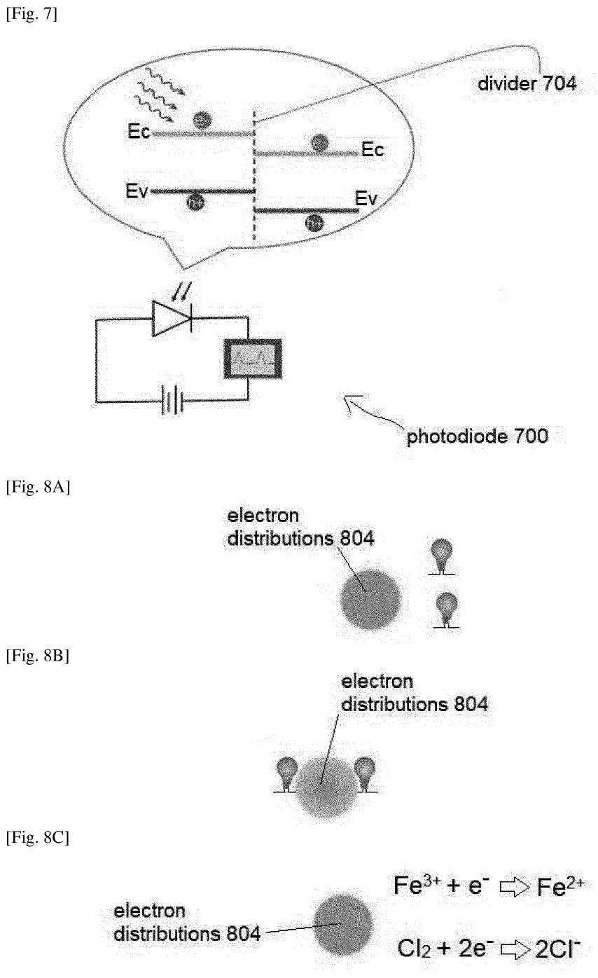

FIGS. 8A-8C shows some potential applications available if using the embodiments herein to control a flow of photoexcited electrons in opposite directions (FIG. 8B) or arbitrary directions (FIG. 8A). The circles 804 symbolize example distributions of the photoexcited electrons. FIGS. 8A and 8B show examples of driving nanoscale circuits, while FIG. 8C shows an example of directing nanoscale currents by causing localized photocatalytic activities at two different spatial locations.

What is claimed is:

1. A method of generating local electric fields that drive spatially varying currents within an optical spot of a semiconductor:
cleaving a semiconductor wafer in-situ in a ultrahigh vacuum chamber of a photoemission electron microscope (PEEM), thereby exposing a clean surface;
a pump pulse photoexciting the wafer such that a plurality of photoexcited electrons are then photoemitted with a time-delayed probe pulse;
arranging an inhomogeneous distribution of the photoexcited carriers thereby creating a spatially nonuniform screening of an intrinsic field;
a gradient of unscreened positive surface charges creating an in-plane surface electric field acting upon the photoexcited electrons and pulling them apart;
the in-plane surface electric field leaving behind an almost completely screened region at the center of the Gaussian pulse and regions with a finite intrinsic field away from the center;
the screened electric surface field causing lateral variations in the amount of band bending, and accordingly a lateral potential difference on the surface; and
the lateral potential difference directly corresponding to the in-plane electric field radiating away from the center responsible for pulling apart the photoexcited electrons.

2. The method of claim 1, further comprising:
weakening the strength of the electric field along a long axis of the ellipse thereby ensuring the photoexcited electrons are pulled apart only in a predetermined direction.

3. The method of claim 3, further comprising:
the predetermined direction being along a short axis of the ellipse.

4. The method of claim 2, further comprising:
performing TR-PEEM measurements of the photoemitted electrons using a time-delayed pump-probe technique; and
a cathode lens design of a TR-PEEM allowing non-scanning, high-resolution imaging of the photoemitted electrons with a predetermined lateral resolution.

5. The method of claim 1, further comprising:
generating the time-delayed probe pulses at a predetermined central wavelength and predetermined duration using a high-power high repetition rate oscillator system operating at a predetermined power and predetermined repetition rate.

6. The method of claim 5, further comprising:
splitting the time-delayed probe pulses into two parts, the first part comprising a pump pulse to photoexcite the wafer, and the second part comprising a frequency tripled time-delayed probe pulse suitable for photoemitting electrons from the wafer.

7. The method of claim 6, further comprising:
the frequency-tripling occurring via BB 0 crystals.

8. The method of claim 1, further comprising:
imaging the photoemitted electrons within the PEEM thereby forming a series of time-delayed images reflecting the evolving spatial distribution of the photoexcited electrons.

9. The method of claim 1, further comprising:
selecting the probe to have a predetermined photon energy and selecting the wafer to have a predetermined electron affinity of the wafer thereby photoemitting only the photoexcited electrons from the wafer.

10. The method of claim 1, further comprising:
arranging a diameter of a short axis of a pump elliptical spot to be a predetermined length.

11. The method of claim 1, further comprising:
configuring a spot corresponding to the probe to a predetermined width suitable for achieving uniform illumination of the field-of-view of the wafer.

12. The method of claim 1, further comprising:
obtaining a temporal resolution of a measurement from a rise time of the pump-probe signal.

13. The method of claim 12, further comprising:
the above step of obtaining further comprising the stretching and frequency-tripling the probe.

14. The method of claim 1, wherein the semiconductor wafer comprises p-doped GaAs.

15. the method of claim 1, wherein the pump pulse comprising 1.55 eV 45 fs.

16. the method of claim 1, wherein the probe pulse comprising 4.6 eV.

17. The method of claim 1, further comprising:
configuring the wafer to be suitable for powering opto-electronic devices.

18. The method of claim 1, further comprising:
spatial light modulators imprinting other non-trivial intensity patterns on the surface of the wafer; thereby
controlling and managing charge currents on the surface of the wafer at a nano-scale.

19. The method of claim 1, further comprising:
spatial light modulators imprinting other non-trivial intensity patterns on the surface of the wafer; thereby
controlling and managing charge currents on the surface of the wafer at a femto-scale.

20. The method of claim 18, further comprising:
the charge currents driving nanoscale opto-electronic devices.

21. The method of claim 19, further comprising:
the charge currents driving localized, temporally-gated photocatalysis with predetermined levels of user-adjustable resolution and control.

22. The method of claim 1, further comprising:
using electron density, diffusion coefficient, electron mobility, and recombination rate as fitting parameters, qualitatively reproducing a distribution profile of the photoexcited electrons.

23. The method of claim 1, further comprising:
transforming the wafer into a field programmable gate array (FPGA) device comprising reconfigurable logic blocks.

24. The method of claim 1, further comprising:
transforming the wafer into a photodiode.

25. The method of claim 1, further comprising:
transforming the wafer into a device for driving nanoscale circuits.

26. The method of claim 1, further comprising:
transforming the wafer into a device for driving nanoscale currents; thereby
causing localized photocatalytic activities at two different spatial locations.

27. A method of testing a plurality of spatially varying currents within the optical spot of a semiconductor, comprising:
taking a LEED pattern of a wafer prior to any measurements;
taking measurements of the wafer;
generating a femtosecond pulses at a predetermined central wavelength and pulse duration using a high-power high repetition rate oscillator system operating at a predetermined power and predetermined repetition rate;
splitting the femtosecond pulses into two parts, the first part comprising a pump pulse to photoexcite the wafer, and the second part comprising a frequency tripled time-delayed probe pulse suitable for photoemitting electrons from the wafer;
taking a LEED pattern of the wafer after any measurements; and
checking for significant surface changes by comparing the before-after LEED patterns.
